(19) United States
(12) Patent Application Publication
(10) Pub. No.: US 2017/0294193 A1
(43) Pub. Date: Oct. 12, 2017

(54) DETERMINING WHEN A SUBJECT IS SPEAKING BY ANALYZING A RESPIRATORY SIGNAL OBTAINED FROM A VIDEO

(71) Applicant: Xerox Corporation, Norwalk, CT (US)

(72) Inventors: Pragathi PRAVEENA, Bengaluru (IN); Prathosh Aragulla PRASAD, Mysore (IN)

(21) Appl. No.: 15/092,287

(22) Filed: Apr. 6, 2016

(51) Int. Cl. G10L 25/45; G10L 25/78; G10L 25/09; G06T 7/20

(52) U.S. Cl. CPC G10L 25/45; G06T 7/2033; G10L 25/78; G10L 25/09; G06T 2207/10016; G06T 2207/30196; G10L 2025/783

(57) ABSTRACT

What is disclosed is a system and method for determining when a subject is speaking from a respiratory signal obtained from a video of that subject. A video of a subject is received and a respiratory signal is extracted from a time-series signal is obtained from processing pixels in image frames of the video. The respiratory signal comprises an inspiratory signal and an expiratory signal. Cycle-level feature are extracted from the respiratory signal and used to identify expiratory signals during which speech is likely to have occurred. The identified expiratory signal are divided into time intervals. Frame-level features are determined for each time interval and an amount of distortion in the expiratory signal for this time interval is quantified. The amount of distortion is compared to a threshold. In response to the comparison, a determination is made that speech occurred during this interval. The process repeats for all time intervals.

### TECHNICAL FIELD

The present invention is directed to systems and methods for determining when a subject is speaking by analyzing a respiratory signal obtained from a video of that subject.

### BACKGROUND

Speech activity detection (SAD) is a key component in speech processing applications and is often used for identifying a presence or absence of speech in an audio signal. Accuracy can influence subsequent processes such as, for example, speech coding, speech recognition, speech enhancement, translation, and the like. Early algorithms for detecting speech focused on features of the speech signal such as energy levels, zero-crossing rates, least squares periodicity estimators, etc. More recent algorithms tend to rely on statistical model-based classifications using a likelihood ratio test involving multiple independent observations, sequential Gaussian mixtures, non-negative matrix factorization, and deep neural networks.

SAD is traditionally implemented using audio signals. With the availability of multi-modal data, visual features can be used in a complementary manner to aid the detection of speech frames. For speech signals embedded in non-stationary noise with a low signal-to-noise ratio (SNR), visual speech can be utilized to help identify speech frames primarily. Such methods often employ lip-tracking techniques, or automated co-speech gesture analysis. Respiratory activity in conversation has not been very well explored in the context of visual speech activity detection. The teachings disclosed herein are directed to enabling visual speech detection.

Accordingly, what is needed in this art are systems and methods for analyzing a respiratory signal obtained from a video of that subject so that speech frames in the video can be identified and isolated.

### BRIEF SUMMARY

What is disclosed is a system and method for determining when a subject is speaking by analyzing a respiratory signal obtained from a video of that subject. Two embodiments are disclosed. A first embodiment facilitates an identification of respiratory cycles in a respiration signal when speech is likely to have occurred. A second embodiment provides further granularity wherein individual segments of a expiratory cycle are identified as when speech is occurring.

In the first embodiment, a video comprising a plurality of time-sequential image frames of a subject is received. The video is acquired over a plurality of respiratory cycles where each respiratory cycle comprises a period of inspiration and a period of expiration followed by a post-expiratory pause. Pixels in a thoracic region of each image frame of the video are processed to obtain a time-series signal. A respiratory signal is extracted from the time-series signal. Respiratory cycles are identified in the respiratory signal and cycle-level features are determined for each respiratory cycle. The cycle-level features are analyzed to identify periods of expiration in which speech is likely to have occurred. In various embodiments, the time intervals of the respiratory cycles during which speech is likely to have occurred are used to filter background noise from an audio of the subject speaking.

In the second embodiment, respiratory cycles are identified in the respiratory signal and cycle-level features are determined for each respiratory cycle. The cycle-level features are analyzed to identify periods of expiration during which speech is likely to have occurred. The expiratory signals associated with each of the identified periods of expiration are divided into a plurality of time intervals. Frame-level features are then determined for each interval. A determination is then made, based on the frame-level features, whether speech occurred during this time interval. The process repeats for all time intervals for each of the identified periods of expiration. Upon completion, in various embodiments, the time intervals during which speech is determined to have occurred are used to filter background noise from an audio of the subject speaking.

Features and advantages of the above-described method will become readily apparent from the following detailed description and accompanying drawings.

### BRIEF DESCRIPTION OF THE DRAWINGS

The foregoing and other features and advantages of the subject matter disclosed herein will be made apparent from the following detailed description taken in conjunction with the accompanying drawings, in which:

FIG. 1 shows an example video imaging device capturing image frames of a region of interest of a subject;

FIG. 2 shows a respiratory cycle of an example segment of a respiratory signal obtained from a time-series signal extracted from a video of the subject of FIG. 1;

FIG. 3 shows a graph of a respiratory signal and a graph of the instantaneous phase for that signal;

FIG. 4 shows a graph of a respiratory signal with the maxima and minima identified for all respiratory cycles;

FIG. 5 shows a respiratory signal where speech activity has occurred doing periods of expiration;

FIG. 6 shows one example respiratory cycle identified within the respiratory signal as being likely when speech occurred;

FIG. 7 is a flow diagram which illustrates one embodiment of the present method for determining when a subject is speaking from a respiratory signal obtained from a video of that subject;

FIG. 8 is a continuation of the flow diagram of FIG. 7 with flow processing continuing with respect to node A;

FIG. 9 shows an audio of the subject which has been isolated and enhanced at various time intervals that have been identified using the techniques disclosed herein on respiratory signal shown overlaid on the noisy audio component of the video; and

FIG. 10 shows a functional block diagram of one embodiment of an example system for performing various aspects of the present method as described with respect to the flow diagrams of FIGS. 7-8.

### DETAILED DESCRIPTION

What is disclosed is a system and method for determining when a subject is speaking from a respiratory signal obtained from a video of that subject.

It should be understood that one of skilled in this art would readily understand various aspects of image processing, and methods for generating time-series signals from pixels obtained from batches of time-sequential image frames in a video and methods for extracting a respiratory signal from the time-series signal. One skilled in this art would also readily understand various signal processing techniques including methods for uncovering independent source signal components from a set of observations that are composed of linear mixtures of underlying sources. Such methods are taught in: “Independent Component Analysis”, Wiley (2001), ISBN-13: 978-0471405405.

### Non-Limiting Definitions

A “subject” is a living being. Although the term “person” or “patient” may be used throughout this text, it should be appreciated that the subject may be something other than a human such as a primate. As such, use of these terms is not to be viewed as limiting the scope of the appended claims strictly to humans.

“Respiratory function” is a process of repeated cycles of inspiration and expiration followed by a brief post-expiratory pause. Inspiration is the process of taking air into the lungs. Expiration is generally a passive process of expelling air from the lungs. A post-expiratory pause occurs when there is a momentary equalization of pressure between the lungs and the surrounding atmosphere. A video is acquired of the subject for processing.

A “video”, as generally understood, is a plurality of time-sequential image frames. The video may also contain other components such as audio, time, date, reference signals, frame rate, and the like. The video may be processed to compensate for motion induced blur, imaging blur, slow illuminant variation or to enhance contrast or brightness.

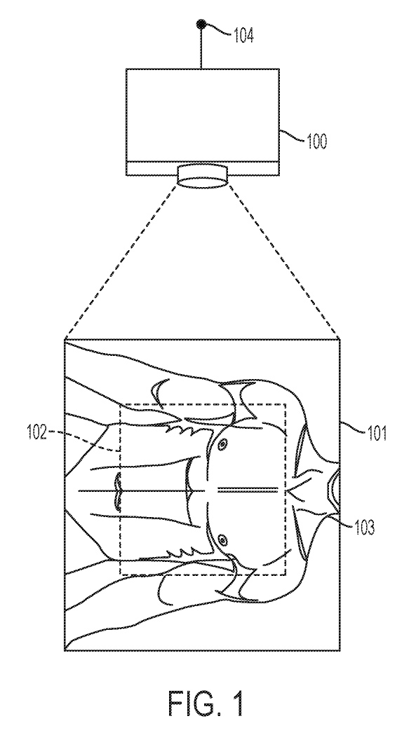

A “video imaging device”, as generally understood, refers to a single-channel or multi-channel video camera for capturing or otherwise acquiring temporally successive images of the subject at a given frame rate. A frame rate (or temporal resolution) of the video camera is the number of image frames captured over a pre-defined unit of time usually in frames per second. Video imaging devices for acquiring video include: a color video camera, a monochrome video camera, an infrared video camera, a multispectral video imaging device, a hyperspectral video camera, or a hybrid device comprising a combination hereof. FIG. 1 shows an example video imaging device 100 capturing image frames (individually at 101) of a thoracic region 102 of a subject 103. The video camera 100 has a communication element 104 (shown as an antenna) which effectuates communication with a remote device such as a computer workstation over a wireless network. The video imaging device has one or more lens which focus received reflected light on to photodetectors which independently record intensity values at pixel locations along a multi-dimensional grid. The received light is spatially resolved to form an image. The video imaging device may incorporate memory, a storage device, and a video analysis module comprising one or more microprocessors for executing machine readable program instructions for analyzing the received video in accordance with the teachings hereof. Such a video analysis module may comprise, in whole or in part, a software application working alone or in conjunction with one or more hardware resources. Video imaging devices comprising standard video equipment and those with specialized imaging sensors are available from a wide array of vendors in various streams of commerce. The video is processed to isolate a region of the body which moves due to an expansion and contraction of the chest during respiration. Body areas which move during respiration include the anterior thoracic region, a side view of the thoracic region, and a back region of the dorsal body. Body areas can be identified in image frames using, for instance, a user input. During system setup and configuration, an operator or technician can use a mouse or a touchscreen display to manually select or draw a rubber-band box around one or more body areas of the video displayed on a monitor or display device to identify pixels for processing. Pixels associated with the identified body area are isolated in the image frames.

“Isolating pixels” in the video can be effectuated using any of a wide array of techniques that are well established in the image processing arts. Such techniques include: pixel classification, spatial features, pattern recognition, object identification such as thoracic region recognition, and spectral information. Pixels may be weighted, averaged, normalized, grouped or discarded, as needed. Groups of pixels may be spatially filtered or amplitude filtered to reduce noise. Pixels may be grouped and their mean, median, standard deviation, or higher order statistics computed. Values of pixels can be aggregated such as, for instance, an algebraic sum of pixel values obtained from each of the imaging channels of the video imaging device used to acquire the video. The isolated pixels are processed in batches of image frames to extract a time-series signal.

A “batch of image frames” refers to a plurality of time-sequential image frames of the received video. Batches of image frames do not have to be the same size and may vary dynamically during processing. A size of a given batch of image frames can be pre-defined by the user depending on the application. An initial size N of a first batch of image frames can be defined such that: Nₘᵢₙ≦N≦Nₘₐₓ, where Nₘᵢₙ is a minimum size of a batch of image frames needed to obtain an accurate time-series signal, and Nₘₐₓ is a user-defined maximum size of a batch of image frames. A size of a given batch of image frames should at least encompass 3 respiratory cycles of the subject. In one embodiment, batches of video frames are created by sliding a window of length 30 (or 15) seconds with 96.67% overlap between consecutive batches which means using only 1 second of new frames and retaining 29 seconds of frames from the prior batch. Pixels isolated in batches of image frames are processed to obtain a time-series signal on a per batch basis. These time-series signals are stitched together to generate a continuous time-series signal.

A “time-series signal” contains frequency components related to the motion of the thoracic cage due to respiratory function. A time series signal is generated by, for instance, averaging the isolated pixel values to obtain a channel average per frame. A global channel average is computed, for each channel, by adding the channel averages across multiple frames and dividing by the total number of frames. The channel average is subtracted from the global channel average and the result is divided by a global channel standard deviation to obtain a zero-mean unit variance signal which contains frequency components. Signal segments, obtained on a per-batch bases, are stitched together to obtain a continuous time-series signal. The time-series signal may be normalized and pre-filtered to remove undesirable frequencies. Various signal segments can be weighted, as desired. Such a weighting may be applied over one or more signal segments while other signal segments are not weighted. Methods for weighting signal segments are widely understood in the signal processing arts. The time-series signal can be filtered using, for example, a band pass filter with a low cutoff frequency f_{L} and a high cutoff frequency f_{H}, where f_{L} and f_{H} are a function of the subject's tidal breathing. The cutoff frequencies may also be a function of the subject's health, age, and other respiratory health-related factors. The filter's cut-off frequencies are preferably selected so that desirable components in the signal are retained while undesirable components are removed.

A “respiratory signal” is a signal which is extracted from the time-series signal and which relates to respiration. A respiratory signal can be extracted from a time-series signal using, for example, a parametric or a non-parametric spectral density estimation on the filtered time-series signal or by performing automatic peak detection on the filtered time-series signal.

“Receiving a respiratory signal” is intended to be widely construed and includes: retrieving, capturing, acquiring, or otherwise obtaining a signal corresponding to respiratory function. The respiratory signal can be retrieved from a memory or storage device of the video imaging device, or obtained from a remote device over a network. The respiratory signal may be retrieved from a media such as a CDROM or DVD, or downloaded from a web-based application which makes such signals available for processing. The respiratory signal can also be received using an application such as those which are widely available for handheld cellular devices and processed on a smartphone or other handheld computing device such as an iPad or Tablet-PC. The respiratory signal is analyzed to identify respiratory cycles.

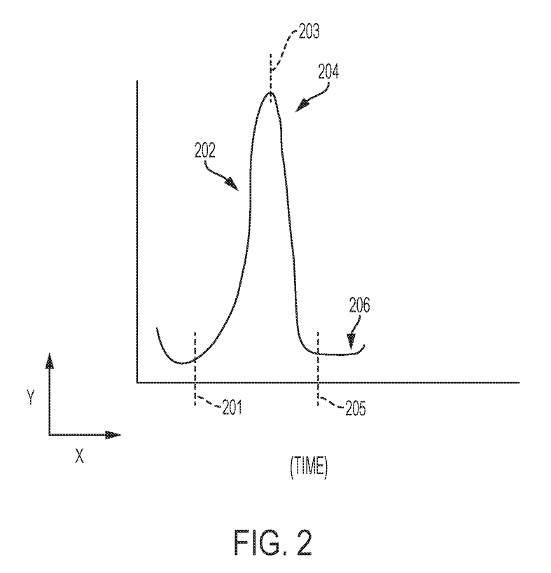

A “respiratory cycle” refers to a period of inspiration, a period of expiration, followed by a post-expiratory pause. Each respiratory cycle in the respiratory signal has an inspiratory signal segment and an expiratory signal segment followed by a signal segment associated with the post-expiratory pause. FIG. 2 shows a respiratory cycle of an example segment of a respiratory signal. The x-axis is time(s) and the y-axis is the amplitude. The respiratory cycle begins at the end of the previous post-expiratory pause (at 201). The period of inspiration (shown at inspiratory signal 201) ends at a peak 203 of this respiratory cycle. The period of expiration (shown at expiratory signal 204) ends 205 at the beginning of the post-expiratory pause (shown as signal segment 206). Respiratory cycles can be determined in the respiratory signal using automatic cycle detection.

### Automatic Cycle Detection

Use a Hilbert transform to construct a complex analytic signal ζ(t) from a scalar time-series signal s(t). Angle variable φ_{H}(t) yields the instantaneous phase for signal ζ(t) using the following relationship:

ζ(t)=s(t)+is_{H}(t)=A(t)e^{iφ}^{_{H}}^{(t)} (1)

where:

[symbol]

(s_{H})(ω)=(−i sgn(ω))· [symbol] (s)(ω) (2)

In a sinusoidal signal, the peaks and valleys would be given by the zero-crossings of the wrapped phase. However, due to deviation of the signal, the zero-crossings may not correspond exactly to the extrema of the signal. As such, the indices obtained from instantaneous phase are used as the approximate index of the true extremum and then search for a maximum or minimum in a small window of, for instance, 30 frames (approximately 1 sec). To ensure that a spurious cycle is not detected: (1) φ_{H}(t)ε[−π, +π], and (2) the respiratory cycle is preferably at least one second in duration.

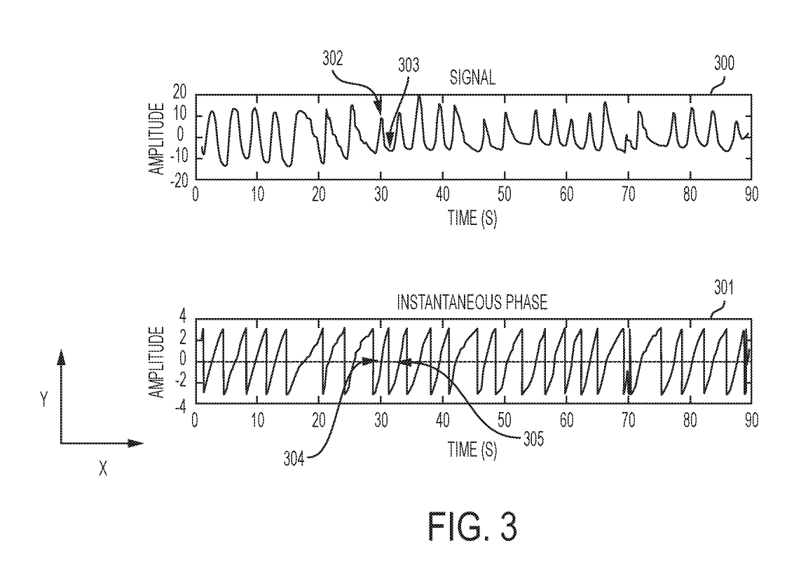

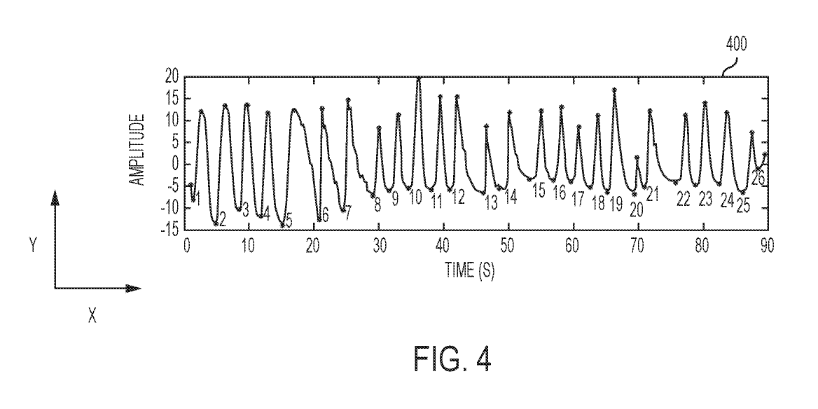

FIG. 3 shows a graph 300 of a respiratory signal and a graph 301 of the computed instantaneous phase 301. The x-axis is seconds and the y-axis is the normalized amplitude. The zero-crossings at time=30.07 secs (at 304) and 31.57 secs (at 305) are used to find the maxima (302) and minima (303) in a given respective respiratory cycle. FIG. 4 shows a graph 400 of a respiratory signal with the maxima and minima identified for all the respiratory cycles. The x-axis is time(sec) and the y-axis is normalized amplitude. Once the respiratory cycles have been identified, cycle-level features are extracted from each respiratory cycle.

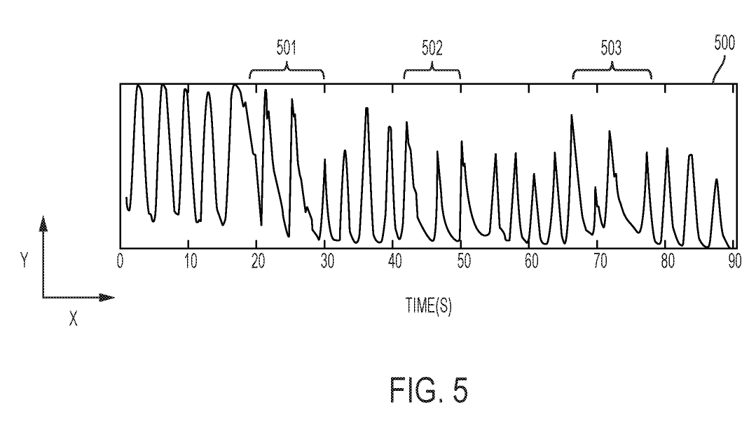

A “cycle-level feature” is a feature which is extracted or otherwise determined for a given respiratory cycle and which helps identify expiratory periods when speech is likely to have occurred. The quasi-sinusoidal respiratory signal is relatively smooth during tidal breathing but the expiratory signal of each respiratory cycle appears saw-toothed during speech. FIG. 5 is a graph 500 which shows a respiratory signal where speech activity has occurred doing periods of expiration 501, 502 and 503. The x-axis is time in seconds and the y-axis is amplitude. Cycle-level features can be determined for a given respiratory cycle by, for example, fitting a Gaussian curve to that segment of the respiratory signal and determining a R-squared goodness-of-fit. If the goodness-of-fit is high then speech is not likely to have occurred during this respiratory cycle. In another embodiment, a variance is computed for the Gaussian curve. If the variance is low then speech is not likely to have occurred during this respiratory cycle. In another embodiment, a volume of an area beneath the Gaussian curve is calculated. If the volume is low speech is not likely to have occurred during this respiratory cycle. Further, a ratio of a duration of a given period of expiration to a duration of a corresponding period of inspiration can be calculated for each respiratory cycle. If the ratio is low speech is not likely to have occurred during this respiratory cycle. It should be appreciated that such determinations herein are based, at least in part, by a comparison having been made to a user-defined threshold. Since such thresholds will be relatively patient-specific, a discussion as to a particular threshold is omitted herein. Once the respiratory cycles when speech is likely to have occurred have been identified, the expiratory signal segment associated with these respiratory cycles are divided into a plurality of time intervals.

### Time Intervals

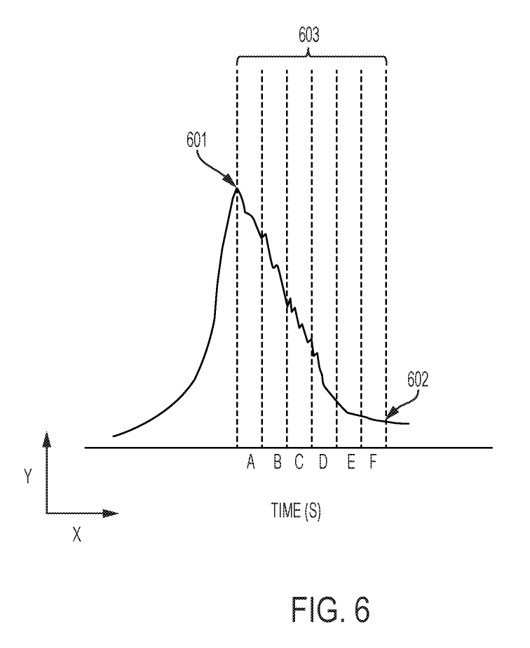

Reference is now being made to FIG. 6 which shows one example respiratory cycle identified within the respiratory signal as being likely when speech occurred. The period of expiration (expiratory signal segment) starts (at 601) and ends at the beginning of the following post-expiratory pause (at 602). The expiratory signal segment of the respiratory cycle of FIG. 6 is shown having been divided into a plurality of time intervals (collectively at 603), and labeled A,B,C,D,E,F for discussion purposes. Given that speech occurs during expiration by the lungs expelling air through the vocal chords, the expiratory signal appears saw-toothed. Time intervals A,B,C,D are shown appearing saw-toothed. As such, it would subsequently be determined that these time intervals are when speech occurred. Time intervals E and F are smooth and thus a it would subsequently be determined that speech did not occur during these time intervals. In one embodiment, the time intervals correspond to the frame rate of the video from which the respiratory signal was extracted. In another embodiment, the time-intervals are selected by a user and may or may not be uniformly temporally-spaced. Once the expiratory signals of each respiratory cycle have been divided into time-intervals, frame-level features are determined.

A “frame-level feature” is determined by calculating a degree of monotonicity of the expiratory signal corresponding to the time interval with a window size of at least 5 intervals. If the degree of monotonicity is low as compared to a threshold then it is determined that speech occurred during this time interval. In another embodiment, zero-crossing dynamics of a moving slope of the expiratory signal corresponding to this time interval are calculated and, if the sign of the slope changes, it is determined that speech occurred during this time interval. In another embodiment, coefficients of a 5-level discrete wavelet transform of the expiratory signal corresponding to this time interval are calculated and, if the detail coefficients has a high amplitude as compared to a threshold. then it is determined that speech occurred during this time interval. In this particular embodiment, the wavelet transform is a Daubechies wavelets.

### Introduction to Daubechies Wavelets

In general, a wavelet is a function ψεL²(R) that yields a basis in L²(R) by means of translations and dyadic dilations of itself, i.e.,

$$f ( x ) = {\sum }_{j = - ∞}^{∞} {\sum }_{k = - ∞}^{∞} {a}_{j} , k ψ ( {2}^{j} x - k ) \qquad ( 3 )$$

for all fεL²(R). Such a decomposition is called the discrete wavelet transform.

The Belgian mathematician Ingrid Daubechies constructed a family of orthogonal wavelets defining a discrete wavelet transform and characterized by a maximal number of vanishing moments for some given support. With each wavelet type of this class, there is a scaling function which generates an orthogonal multi-resolution analysis. Daubechies wavelet functions ψ [symbol] , [symbol] εN\{0} satisfy the property that the collection ψ [symbol] (x−k),kε [symbol] is an orthonormal system for fixed [symbol] εN\{0}, that each wavelet ψ [symbol] is compactly supported, and that supp(ψ [symbol] )=[0,2N−1]. The index N is related to the number of vanishing moments, i.e.,

∫_{-∞}^{∞}x^{k}ψ [symbol] (x)dx=0,0≦k≦N (4)

A last important property of the Daubechies wavelets is that their regularity increases linearly with their support width. In fact, for large N, λ≈0.2.

The Daubechies wavelets are neither symmetric nor asymmetric around any axis, except for ψ1 which is the Haar wavelet. The Daubechies wavelets can also be used for the continuous wavelet transform, i.e.

$${W}_{ψ} [ f ] ( a , b ) = \frac{1}{\sqrt{a}} {\int }_{- ∞}^{∞} f ( x ) ψ ( \frac{x - b}{a} ) dx \qquad ( 5 )$$

For fεL²(R), aεR⁺ and bεR, where a and b denote scale and translation/position of the transform.

A stable reconstruction formula exists for the continuous wavelet transform if and only if the following admissibility condition holds:

$$0 < {C}_{ψ} = 2 π {\int }_{0}^{∞} \frac{{\vert \hat{ψ} ( a ω ) \vert}^{2}}{a} da < ∞ \qquad ( 6 )$$

where \hat{ψ} denotes the Fourier transform of ψ.

The reconstruction formula reads:

$$f ( x ) = \frac{1}{{C}_{ψ}} {\int }_{0}^{∞} {\int }_{- ∞}^{∞} {W}_{ψ} [ f ] ( a , b ) ψ ( \frac{x - b}{a} ) db \frac{da}{\sqrt[a]{a}} \qquad ( 7 )$$

This result holds weakly in L²(R). For fεL¹(R)∩L²(R) and \hat{f}εL¹(R), this also holds point-wise. Daubechies wavelets satisfy the admissibility condition and thus guarantee a stable reconstruction.

The reader is directed to the “Orthonormal Bases Of Compactly Supported Wavelets”, Ingrid Daubechies, Comm. Pure Appl. Math, 41, 909-996, (1988), and the introductory text: “Ten Lectures on Wavelets”, Ingrid Daubechies, SIAM: Society for Industrial and Applied Mathematics; 1st Ed. (May 1992), ISBN-13: 978-0898712742.

It should be appreciated that the recited steps of: “receiving”, “processing”, “dividing”, “analyzing”, “comparing”, “using”, “determining”, “performing”, “associating”, and the like, include the application of any of a variety of signal processing techniques as are known in the signal processing arts, as well as mathematical operations according to any specific context or for any specific purpose. It should be appreciated that such steps may be facilitated or otherwise effectuated by a microprocessor executing machine readable program instructions such that an intended functionality can be effectively performed.

### Example Flow Diagram

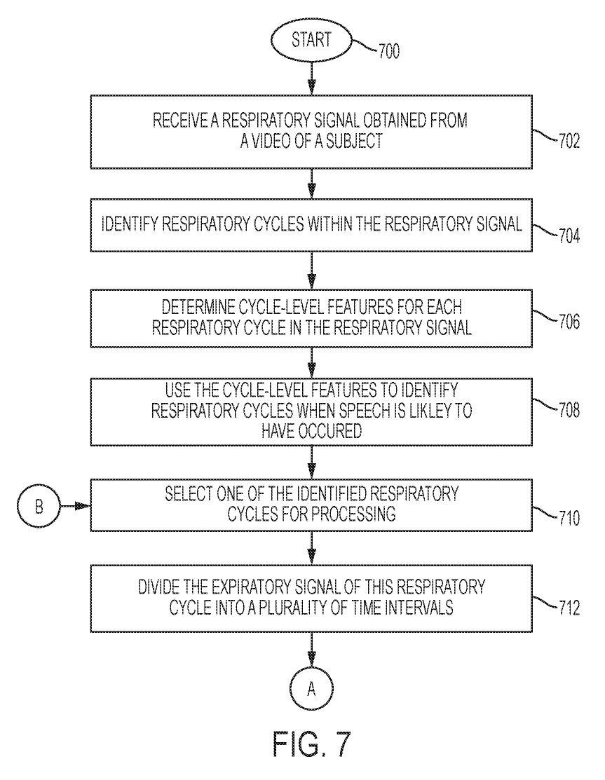

Reference is now being made to the flow diagram of FIG. 7 which illustrates one embodiment of the present method for determining when a subject is speaking from a respiratory signal obtained from that subject. Flow processing begins at step 700 and immediately proceeds to step 702.

At step 702, receive a respiratory signal obtained from a video of a subject. The respiratory signal comprises a plurality of respiratory cycles. Each respiratory cycle comprises an inspiratory signal and an expiratory signal followed by a post-expiratory pause. The respiratory signal is extracted from a time-series signal obtained from processing pixels of a plurality of time-sequential image frames of the video of the subject.

At step 704, identify respiratory cycles within the respiratory signal. FIG. 4 shows example respiratory cycles identified within a respiratory signal of a subject.

At step 706, determine at least one cycle-level feature for each respiratory cycle. Various methods for determining cycle-level features are discussed herein in detail.

At step 708, use the cycle-level features to identify respiratory cycles when speech is likely to have occurred.

At step 710, select one of the respiratory cycles for processing.

At step 712, divide the expiratory signal of this respiratory cycle into a plurality of time intervals. FIG. 6 shows one example expiratory signal having been divided into a plurality of time intervals.

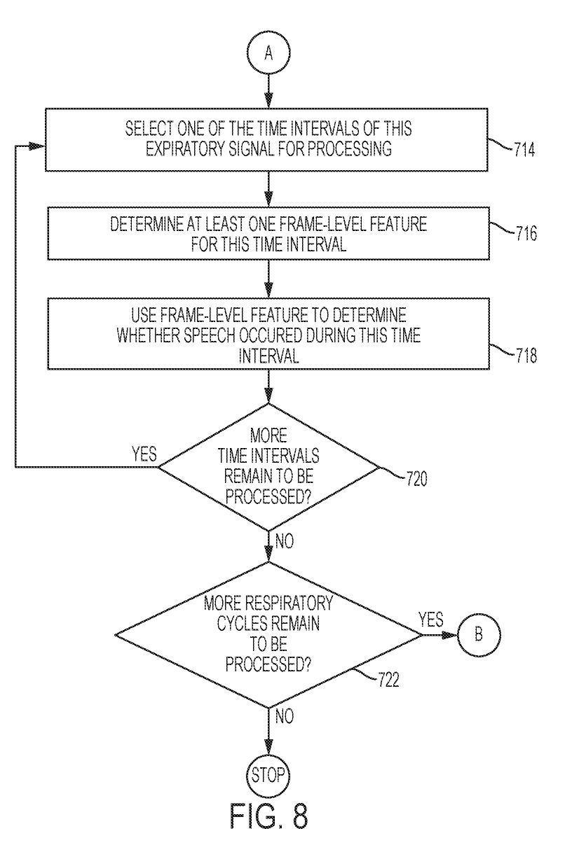

Reference is now being made to FIG. 8 which is a continuation of the flow diagram of FIG. 7 with flow processing continuing with respect to node A.

At step 714, select one of the time intervals of this expiratory signal for processing.

At step 716, determine at least one frame-level feature for this time interval. Various methods for determining frame-level features are discussed herein in detail.

At step 718, use the frame-level feature to determine whether speech occurred during this interval.

At step 720, a determination is made whether more time intervals remain to be process. If so then processing repeats with respect to step 714 wherein a next time interval for the current expiratory signal being processed is selected. Processing repeats for all time intervals for the current expiratory signal until no more time intervals remain to be processed.

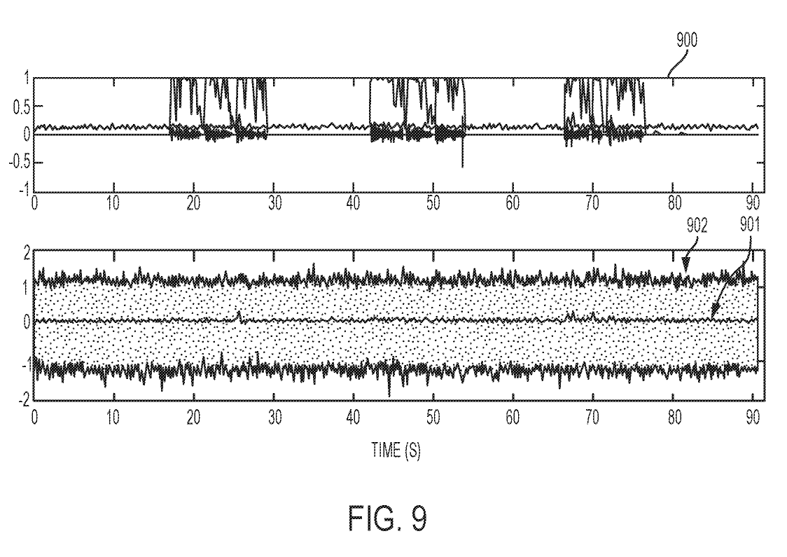

At step 722, a determination is made whether more of the identified respiratory cycles remain to be processed. If so then processing repeats with respect to node B wherein, at step 710, a next respiratory cycle is selected for processing. Processing repeats for all of the identified respiratory cycles until no more respiratory cycles remain to be processed. Thereafter, in this embodiment, further processing stops. In another embodiment, the time intervals when speech is determined to have occurred are used to filter background noise from an audio of the subject speaking or, alternatively, to enhance the audio of the speaker. FIG. 9 shows an audio 900 of the subject which has been isolated and enhanced at various time intervals that have been identified using the techniques disclosed herein on respiratory signal 901 (shown overlaid on the noisy audio component 902 of the video).

It should be appreciated that the flow diagrams depicted herein are illustrative. One or more of the operations in the flow diagrams may be performed in a differing order. Other operations may be added, modified, enhanced, or consolidated. Variations thereof are intended to fall within the scope of the appended claims. Various steps of the flow diagrams may be performed by one or more processors executing machine readable program instructions obtained from a memory.

### Functional Block Diagram

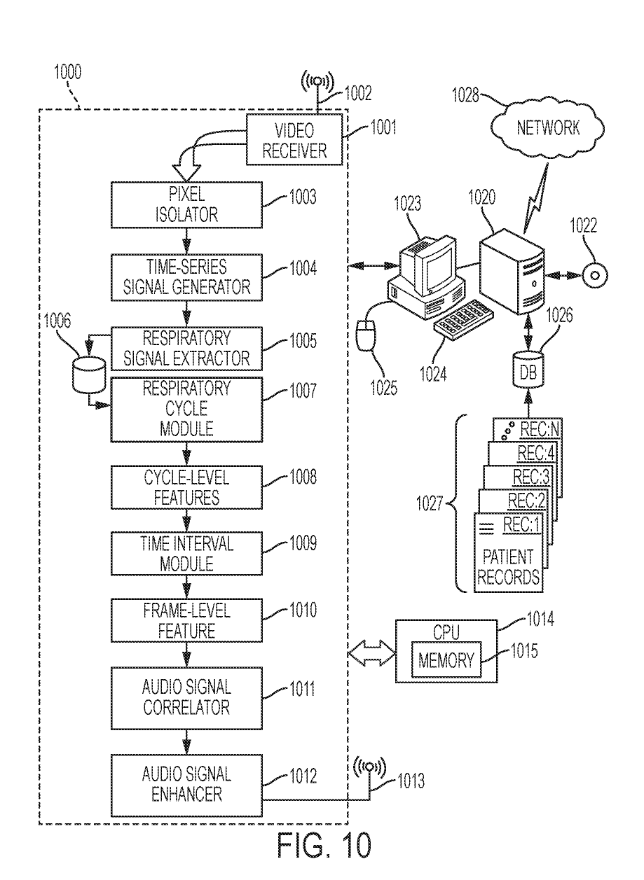

Reference is now being made to FIG. 10 which shows a functional block diagram of one embodiment of an example system 1000 for performing various aspects of the present method as described with respect to the flow diagrams of FIGS. 7-8.

Video Receiver 1001 wirelessly receives the video via antenna 1002 having been transmitted thereto from the video imaging device 100 of FIG. 1. Pixel Isolator Module 1103 processes the received video and proceeds to isolate pixels in the thoracic region of the subject in the video. Time-Series Signal Generator 1004 generates a time-series signal for each of the isolated pixels or, alternatively, for groups of isolated pixels, in a temporal direction across a defined duration of time-sequential image frames. Respiration Signal Extractor 1005 receives the time-series signals and extracts a respiratory signal therefrom. The respiratory signal is stored to storage device 1006. Respiratory Cycle Module 1007 retrieves the respiratory signal from the storage device and proceeds to find individual respiratory cycles therein. Cycle-Level Feature Module 1008 receives the identified individual respiratory cycles and proceeds to determine cycle-level features for each respiratory cycle and, further, to identify which of the respiratory cycles are when speech is likely to have occurred. Time Interval Module 1009 divides the expiratory signal for each of the identified respiratory cycles when speech is likely to have occurred into a plurality of time intervals. Alternatively, a user manually selects or enters a desired time interval using, for example, the computer workstation 1020. Frame-Level Feature Module 1010 receives the expiratory signal segments associated with each of the time intervals for each of the identified respiratory cycles when speech is likely to have occurred and proceeds to determine one or more frame-level features for each time interval and, further, generates, for each time interval, a determination whether speech occurred. Audio Signal Correlator Module 1011 receives the time intervals determined to be when speech occurred and proceeds to correlate those time intervals with the audio component of the video of the subject. Audio Signal Enhancer 1012 proceeds to enhance the correlated audio component of the video for each of the time intervals when it has been determined that speech occurred. The enhanced audio of the subject speaking is then communicated (via antenna 1013) to a receiver of a sound system for the audience listening to the subject speaking. The audio signal generated by Module 1012 may be received and viewed on the display device 1023 of the workstation and/or communicated to one or more remote devices over network 1028. Such a network may utilize a wired, wireless, or cellular communication protocol.

It should be appreciated, at this point, that the video of the subject is acquired and processed in real-time as a streaming video with the processing methods hereof being performed in real-time and the audio being enhanced and communicated with only a minor of time delay (subject, of course, to the limitations of the system performing the processing steps disclosed herein).

Central Processing Unit (CPU) 1014 retrieves machine readable program instructions from a memory 1015 and is provided to facilitate the functionality of any of the modules of the system 1000. The CPU, operating alone or in conjunction with other processors, may be configured to assist or otherwise perform the functionality of any of the modules or processing units of the system 1000, as well as facilitating communication between the system 1000 and the workstation 1020.

Workstation 1020 has a computer case which houses various components such as a motherboard with a processor and memory, a network card, a video card, a hard drive capable of reading/writing to machine readable media 1022 such as a floppy disk, optical disk, CD-ROM, DVD, magnetic tape, and the like, and other software and hardware as is needed to perform the functionality of a computer workstation. The workstation includes a display device 1023, such as a CRT, LCD, or touchscreen display, for displaying information including the video, image frames, time-series signal, respiratory signal, computed values, interim values, and the like, which are produced or are otherwise generated by any of the modules or processing units of the system 1000. A user can view any such information and make a selection from various menu options displayed thereon. Keyboard 1024 and mouse 1025 effectuate a user input.

It should be appreciated that the workstation 1020 has an operating system and other specialized software configured to display alphanumeric values, menus, scroll bars, dials, slideable bars, pull-down options, selectable buttons, and the like, for entering, selecting, modifying, and accepting information needed for performing various aspects of the methods disclosed herein. A user may use the workstation to identify a set of image frames of interest, select respiratory signal segments for processing, select expiratory signals or segments thereof for processing, select regions of pixels to be isolated and processed, set values for various parameters and threshold levels, and otherwise facilitate the functionality of any of the modules or processing units of the system 1000. A user or technician may utilize the workstation to adjust various parameters being utilized or dynamically adjust in real-time, system or settings of any device used to capture the video or processed that video to obtain a respiratory signal. User inputs and selections may be stored/retrieved using any of the storage devices 1006, 1022 and 1026. Default settings and initial parameters can be retrieved from any of the storage devices.

The workstation implements a database in storage device 1026 wherein patient records are stored, manipulated, and retrieved in response to a query. Such records, in various embodiments, take the form of patient medical history, respiratory health, age, and the like, collectively stored in association with information identifying the patient (collectively at 1027). It should be appreciated that database 1026 may be the same as storage device 1006 or, if separate devices, may contain some or all of the information contained in either device. Although the database is shown as an external device, the database may be internal to the workstation mounted, for example, on a hard disk therein.

Although shown as a desktop computer, it should be appreciated that the workstation can be a laptop, mainframe, tablet, notebook, smartphone, or a special purpose computer such as an ASIC, or the like. The embodiment of the workstation is illustrative and may include other functionality known in the arts. The workstation 1020 may be placed in communication with any of the modules of system 1000 or any devices placed in communication therewith. Moreover, any of the modules of system 1000 can be placed in communication with storage device 1026 and/or computer readable media 1022 and may store/retrieve therefrom data, variables, records, parameters, functions, machine readable/executable program instructions, and the like, as needed to perform their intended functionality. Further, any of the modules or processing units of the system 1000 may be placed in communication with one or more remote devices over network 1028. It should also be appreciated that some or all of the functionality performed by any of the modules or processing units of system 1000 can be performed, in whole or in part, by the workstation 1020. The embodiment shown is illustrative and should not be viewed as limiting the scope of the appended claims strictly to that system or configuration. Various modules may designate one or more components which may, in turn, comprise software and/or hardware designed to perform the intended function.

The teachings hereof can be implemented in hardware or software using any known or later developed systems, structures, devices, and/or software by those skilled in the applicable arts without undue experimentation from the functional description provided herein with a general knowledge of the relevant arts. One or more aspects of the methods described herein are intended to be incorporated in an article of manufacture. The article of manufacture may be shipped, sold, leased, or otherwise provided separately either alone or as part of a product suite or a service.

The above-disclosed and other features and functions, or alternatives thereof, may be desirably combined into other different systems or applications. Presently unforeseen or unanticipated alternatives, modifications, variations, or improvements may become apparent and/or subsequently made by those skilled in this art which are also intended to be encompassed by the following claims.

What is claimed is:

1. A method for determining when a subject is speaking from a respiratory signal obtained from that subject, the method comprising:
receiving a respiratory signal obtained from a subject, the respiratory signal having been extracted from a time-series signal obtained from processing pixels of a plurality of time-sequential image frames of the video of the subject, the respiratory signal comprising a plurality of respiratory cycles;
identifying respiratory cycles within the respiratory signal;
determining at least one cycle-level feature for each respiratory cycle; and
using the cycle-level feature to identify respiratory cycles when speech is likely to have occurred.

2. The method of claim 1, wherein identifying respiratory cycles within the respiratory signal comprises automatic cycle detection utilizing an instantaneous phase function and a Hilbert transform.

3. The method of claim 1, wherein determining at least one cycle-level feature for each respiratory cycle and using the cycle-level feature to identify respiratory cycles when speech is likely to have occurred comprises:
fitting a Gaussian curve to the respiratory signal for this respiratory cycle;
determining a R-squared goodness-of-fit; and
determining, in response to the goodness-of-fit being low, that speech is likely to have occurred during this respiratory cycle.

4. The method of claim 1, wherein determining at least one cycle-level feature for each respiratory cycle and using the cycle-level feature to identify respiratory cycles when speech is likely to have occurred comprises:
fitting a Gaussian curve to the respiratory signal for this respiratory cycle;
determining a variance of the Gaussian curve; and
determining, in response to the variance being high as compared to a threshold, that speech is likely to have occurred during this respiratory cycle.

5. The method of claim 1, wherein determining at least one cycle-level feature for each respiratory cycle and using the cycle-level feature to identify respiratory cycles when speech is likely to have occurred comprises:
fitting a Gaussian curve to the respiratory signal for this respiratory cycle;
determining a volume of an area beneath the Gaussian curve; and
determining, in response to the volume being high as compared to a threshold, that speech is likely to have occurred during this respiratory cycle.

7. The method of claim 1, wherein determining a cycle-level feature comprises:
calculating a ratio of a duration of the expiratory period to a duration of the inspiratory period for a given respiratory cycle; and
determining, in response to the ratio being high as compared to a threshold, that speech is likely to have occurred during this respiratory cycle.

8. The method of claim 1, further comprising:
dividing an expiratory signal of each identified respiratory cycles when speech is likely to have occurred into a plurality of time intervals; and
for each of the time intervals:
determining at least one frame-level feature for this interval; and
using the frame-level feature to determine whether speech occurred during this interval.

9. The method of claim 8, wherein the time interval corresponds to a frame rate of the video from which the respiratory signal was obtained.

10. The method of claim 8, wherein determining at least one frame-level feature and using the frame-level feature to determine whether speech occurred during this interval comprises:
determining a degree of monotonicity of the expiratory signal corresponding to this time interval with a window size of at least 5 intervals; and
determining, in response to the degree of monotonicity being low as compared to a threshold, that speech occurred during this time interval.

11. The method of claim 8, wherein determining at least one frame-level feature and using the frame-level feature to determine whether speech occurred during this interval comprises:
calculating zero-crossing dynamics of a moving slope of the expiratory signal corresponding to this time interval; and
determining, in response to the sign of the slope changing, that speech occurred during this time interval.

12. The method of claim 8, wherein determining at least one frame-level feature and using the frame-level feature to determine whether speech occurred during this interval comprises:
calculating coefficients of a 5-level discrete wavelet transform of the expiratory signal corresponding to this time interval; and
determining, in response to the detail coefficients having a high amplitude as compared to a threshold, that speech occurred during this time interval.

13. The method of claim 1, further comprising any of:
using the time intervals during which speech is determined to have occurred to filter background noise from an audio of the subject speaking; and
using the time intervals during which speech is determined to have occurred to enhance an audio of the subject speaking.

14. A system for determining when a subject is speaking from a respiratory signal obtained from a video of that subject, the system comprising:
a storage device; and
a processor in communication with the storage device, the processor executing machine readable instructions for performing:
receiving a respiratory signal obtained from a subject, the respiratory signal having been extracted from a time-series signal obtained from processing pixels of a plurality of time-sequential image frames of the video of the subject, the respiratory signal comprising a plurality of respiratory cycles;
identifying respiratory cycles within the respiratory signal;
determining at least one cycle-level feature for each respiratory cycle; and
using the cycle-level feature to identify respiratory cycles when speech is likely to have occurred.

15. The system of claim 14, wherein identifying respiratory cycles within the respiratory signal comprises automatic cycle detection utilizing an instantaneous phase function and a Hilbert transform.

16. The system of claim 14, wherein determining at least one cycle-level feature for each respiratory cycle and using the cycle-level feature to identify respiratory cycles when speech is likely to have occurred comprises:
fitting a Gaussian curve to the respiratory signal for this respiratory cycle;
determining a R-squared goodness-of-fit; and
determining, in response to the goodness-of-fit being low as compared to a threshold, that speech is likely to have occurred during this respiratory cycle.

17. The system of claim 14, wherein determining at least one cycle-level feature for each respiratory cycle and using the cycle-level feature to identify respiratory cycles when speech is likely to have occurred comprises:
fitting a Gaussian curve to the respiratory signal for this respiratory cycle;
determining a variance of the Gaussian curve; and
determining, in response to the variance being high as compared to a threshold, that speech is likely to have occurred during this respiratory cycle.

18. The system of claim 14, wherein determining at least one cycle-level feature for each respiratory cycle and using the cycle-level feature to identify respiratory cycles when speech is likely to have occurred comprises:
fitting a Gaussian curve to the respiratory signal for this respiratory cycle;
determining a volume of an area beneath the Gaussian curve; and
determining, in response to the volume being high as compared to a threshold, that speech is likely to have occurred during this respiratory cycle.

19. The system of claim 14, wherein determining a cycle-level feature comprises:
calculating a ratio of a duration of the expiratory period to a duration of the inspiratory period for a given respiratory cycle; and
determining, in response to the ratio being high as compared to a threshold, that speech is likely to have occurred during this respiratory cycle.

20. The system of claim 14, further comprising:
dividing an expiratory signal of each identified respiratory cycles when speech is likely to have occurred into a plurality of time intervals; and
for each of the time intervals:
determining at least one frame-level feature for this time interval; and
using the frame-level feature to determine whether speech occurred during this interval.

21. The system of claim 20, wherein the time interval corresponds to a frame rate of the video from which the respiratory signal was obtained.

22. The system of claim 20, wherein determining at least one frame-level feature and using the frame-level feature to determine whether speech occurred during this interval comprises:
determining a degree of monotonicity of the expiratory signal corresponding to this time interval with a window size of at least 5 intervals; and
determining, in response to the degree of monotonicity being low as compared to a threshold, that speech occurred during this time interval.

23. The system of claim 20, wherein determining at least one frame-level feature and using the frame-level feature to determine whether speech occurred during this interval comprises:
calculating zero-crossing dynamics of a moving slope of the expiratory signal corresponding to this time interval; and
determining, in response to the sign of the slope changing, that speech occurred during this time interval.

24. The system of claim 20, wherein determining at least one frame-level feature and using the frame-level feature to determine whether speech occurred during this interval comprises:
calculating coefficients of a 5-level discrete wavelet transform of the expiratory signal corresponding to this time interval; and
determining, in response to the detail coefficients having a high amplitude as compared to a threshold, that speech occurred during this time interval.

25. The system of claim 14, further comprising any of:
using the time intervals during which speech is determined to have occurred to filter background noise from an audio of the subject speaking; and
using the time intervals during which speech is determined to have occurred to enhance an audio of the subject speaking.
